(19) United States
(12) Patent Application Publication
(10) Pub. No.: US 2002/0077949 A1
(43) Pub. Date: Jun. 20, 2002

(54) System and method of investment screening for shari' ah-based compliance

(76) Inventors: Bashar M. Qasem, Fairfax, VA (US); Scott Valpey, Alexandria, VA (US); Jamal M. Barmil, Falls Church, VA (US)

Correspondence Address: Maria Comninou, Esq., Kirkpatrick & Lockhart LLP, Henry W. Oliver Bldg., 535 Smithfield Street, Pittsburgh, PA, 15222-2312, US

(21) Appl. No.: 09/740,714

(22) Filed: Dec. 19, 2000

(51) Int. Cl. G06F 17/60

(52) U.S. Cl. 705/36

(57) ABSTRACT

A method of screening a company for compliance to Shariàh-based principles includes first screening the company for compliance to a permitted ratio for debt over assets and debt over market capitalization, a permitted ratio for accounts receivable over assets, and a permitted ratio for interest income over revenue. Then the method includes screening the company for approval of reported Standard Industrial Classification codes. Subsequently the method includes screening the company for compliance to a permitted ratio for the sum of interest income over revenue and disapproved revenue percentage, and to a permitted ratio for the sum of the percentage of interest income and disapproved lines of business income and the largest of the ratios of debt over assets and debt over market capitalization. Subsequently the method also includes screening the company through a subjective filter. Subsequent screening of the company stops, if the company is rejected by the previous screening.

### CROSS-REFERENCE TO RELATED APPLICATIONS

Not applicable.

### FEDERALLY SPONSORED RESEARCH

Not applicable.

### BACKGROUND OF THE INVENTION

1. Field of the Invention

The invention relates to a system and method for screening financial investments and, more particularly, to a system and method for screening financial investments for compliance with Islamic or Shariàh based principles.

2. Description of the Invention Background

Tracing their roots to the anti-war, environmental and anti-apartheid movements of the 1960's and 1970's, socially responsible or ethical investment funds have been established and operate on the principles of excluding certain publicly-traded stocks and securities, which are considered by their customers to be socially harmful. The CALVERT GROUP, for example, operates portfolios that screen for workplace issues, the environment, weapons contracting, product safety and impact, indigenous people's rights and international operations and human rights.

Another type of investment and financial screening is required for investors who adhere to economic principles based on Islamic law or Shariàh. Over the centuries, Islamic laws (Shariàh) regulating business, finance, and the marketplace in general kept apace of development. In recent years, Shariàh has been interpreted in light of the modern business environment, and many of its precepts have been analyzed with respect to current business practices and capital structures. In the modern marketplace, compliance with Shariàh-based principles has become a complex matter requiring application of qualitative and quantitative standards, both at the time of investment and on a continuous basis, keeping abreast with current Shariàh scholarship and interpretation.

The qualitative standards for compliance with Shariàh-based exclude investment and trading in stocks of companies whose primary business falls within a forbidden category, such as, for example, interest-based financial intermediary services, pork products, alcohol, pornography, etc. The quantitative standards, on the other hard, provide permitted ratios of certain financial practices, which would otherwise be ideally avoided, such as borrowing funds to finance a business. The combination of qualitative and quantitative rules and restrictions and the need for ongoing monitoring to ascertain continued compliance makes the screening for Shariàh-based compliance a very time-consuming and labor-intensive process. The Dow Jones Islamic Market Index (DJIMI), for example, is created from the Dow Jones Global Index (DJGI) by first screening out companies with unacceptable primary business, and then screening the remaining companies for compliance with permitted financial ratios. This approach requires an inordinate amount of manual, non-automated work.

There remains, therefore, a need for an improved screening process for Shariàh-based compliance that overcomes the limitations, shortcomings and disadvantages of the prior-art screening systems.

### SUMMARY OF THE INVENTION

The invention meets the identified needs, as well as other needs, as will be more fully understood following a review of this specification and drawings.

One embodiment of the invention discloses a method of screening a company for compliance to Shariàh-based principles. The method may include the following steps. First, screening the company for compliance to a permitted ratio for debt over assets and/or debt over market capitalization, a permitted ratio for accounts receivable over assets and/or accounts receivable over market capitalization, and a permitted ratio for interest income over revenue. It also may include screening the company for approval of reported Standard Industrial Classification codes. Subsequently, screening the company for compliance to a permitted ratio for the sum of interest income over revenue and disapproved revenue percentage, and to a permitted ratio for the sum of the percentage of interest income and disapproved lines of business income and either the largest or one of the ratios of debt over assets and debt over market capitalization. Subsequently, screening the company through a subjective filter. Subsequent screening of the company stops, if the company is rejected by the previous screening.

Another embodiment of the invention is a method of managing according to Shariàh-based principles an investment portfolio associated with a plurality of companies. This embodiment may include first retrieving automated computer retrievable data for each company and applying an Shariàh-based filter for each company using the automated computer retrievable data. Next, the method may include retrieving manually (i.e. not in an automated manner) retrievable data for each company that has not been rejected by the previous application of the Shariàh-based filter and re-applying the Shariàh-based filter using the manually retrievable data. The sequence of retrieval and screening is such that the number of companies for which manual data must be retrieved is minimized. Other embodiments of the invention include representative sequences for retrieving company data and screening according to Shariàh-based rules and precepts.

A system associated with the method is also disclosed. The system may include means for retrieving and storing quantitative, qualitative and subjective data about a company in the investment portfolio. The system may also include means for screening the quantitative and qualitative and subjective data. The retrieval means are sequenced so that the manual retrieval of data is minimized.

The invention provides a highly efficient Shariàh-based compliance method and system, which minimize the amount of manual retrieval and, therefore, the time, effort and expense required for the application of the Shariàh-based screening rules. The invention, for example, has reduced the number of companies for which information must be retrieved manually by a factor greater than four. This great reduction in manual labor and the corresponding savings is achieved without compromising the strict adherence of the filter to the Shariàh-based principles. On the contrary, because the number of companies that need to be manually screened is greatly reduced, it is possible to do an expanded qualitative and subjective screening without significantly impacting the overall efficiency of the method.

Other features and advantages of the invention will become apparent from the detailed description of the embodiments set forth herein and from the appended claims.

### BRIEF DESCRIPTION OF THE DRAWINGS

FIG. 1 is diagram showing the operation of a filter according to an embodiment of the present invention;

FIG. 2 is a diagram showing an embodiment of a system for screening investments according to the invention; and

FIG. 3 is a flowchart showing an embodiment of a method of screening investments according to the invention.

### DETAILED DESCRIPTION OF THE INVENTION

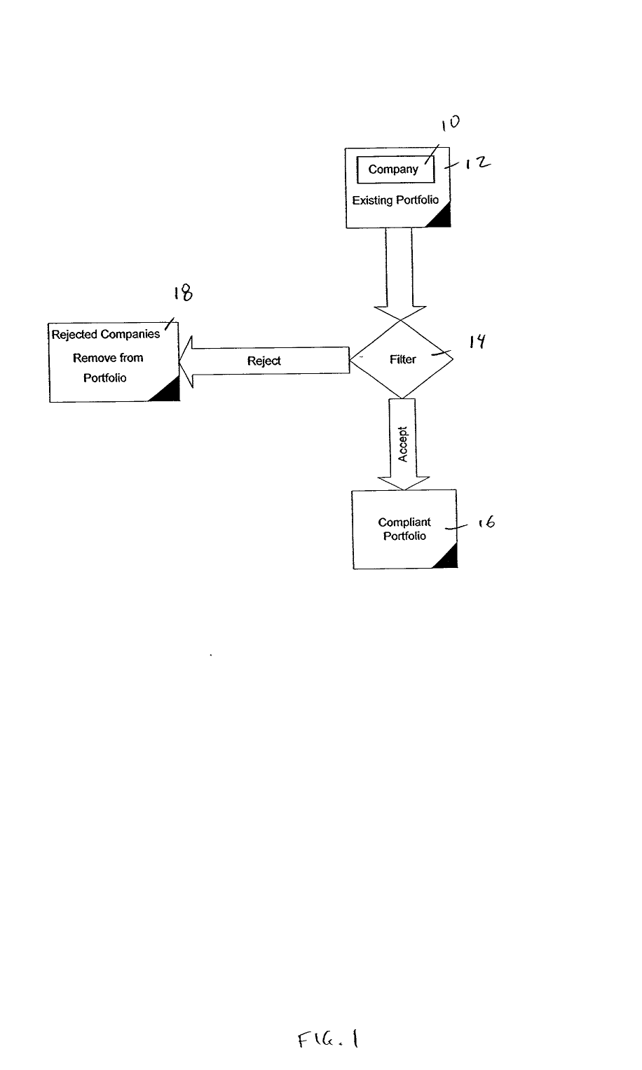

In the following description reference is made to FIGS. 1-3, for the purpose of illustrating the invention and not for the purpose of limiting the same. It is to be understood that other embodiments incorporating structural changes may be utilized without departing from the scope of the invention. The invention uses screens or filters to produce a portfolio of companies compliant with Shariàh-based laws and principles for the purposes of investment. The words screen and filter are used interchangeably herein in describing aspects of the invention, such that “screen” and “filter” generally refers to a device performing a process that checks a company for compliance with one or more Shariàh-based rules, rejecting the company if it fails to comply with the rule and accepting the company if it complies with the rule. A rejected company is stopped by the filter and excluded from the Shariàh portfolio. An accepted company is allowed to pass through the filter to subsequent filters until it is finally rejected or accepted for inclusion in the Shariàh portfolio. “Screening” or “filtering” refers to the process itself.

As shown in FIG. 1, each company 10 in an existing investment portfolio 12 is passed through a Shariàh filter 14. If the filter accepts the company, then the company becomes a constituent of a portfolio 16 compliant to Shariàh-based principles. If the filter rejects the company, then the company is removed from the portfolio and may be held in a storage file of rejected companies 18. The filtering process may be applied to a portfolio that has not been previously checked for Shariàh-based compliance or to a portfolio that may have been compliant in the past to ensure its current compliance. Given the fact that a company's profile and holdings may change overnight through mergers, acquisitions, contracts, new ventures and investments, sales, financing or any other financial transactions and strategic alliances, a screening process will not inspire confidence, and indeed may compromise the closely held beliefs of those who invest in a portfolio and presume it to be compliant, unless screening for compliance is performed daily or even several times a day, depending on circumstances. The speed, reliability and efficiency of the screening process shown in FIG. 1 are, therefore, of paramount significance. A unique aspect of the present invention is that it provides a vastly faster and at the same time flexible and reliable filter over the prior art Islamic filters.

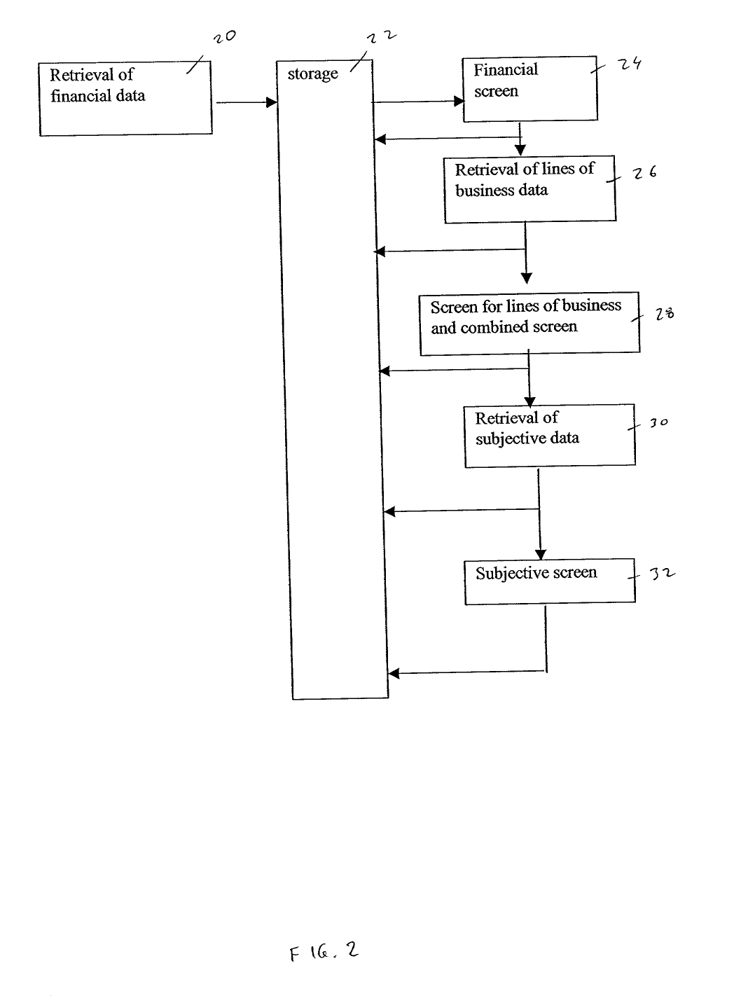

An embodiment of a system and associated method encompassing the present invention are illustrated diagrammatically in FIG. 2. The system includes retrieval means 20, 26, 30, storage means 22 and screening means 24, 28, 32. The retrieval means 20, 26, 30 are such that a wide range of resources available to investors may be utilized to obtain an accurate and flexible filter which can accommodate not only changes in the profile of the portfolio companies, which may affect continued compliance, but also new interpretations of Islamic law or Shariàh in view of current business practices and new ethical dilemmas. Such retrieval means include electronic communication lines to the Internet or to private networks for retrieving financial data in commercial databases, such as those provided by Primark Corporation, of Waltham, Mass., in its Internet site “PiranhaWeb.com”. One of the databases made available online by Primark Corporation, the Worldscope database, offers coverage of over 24,000 public companies in more than 50 developed and emerging markets. The financial data retrieval means 20 include communication access to a database such as Worldscope, which is available in various delivery platforms in addition to the Internet platform, such as, for example, CD-ROM, direct datafeed, magnetic tape etc. Therefore, the financial data retrieval means 20 may include computer means with computer network connections, magnetic tape and CD-ROM reading means, etc. In general, financial data retrieval is fast, automated and computerized.

Information about the lines of business of a particular company may be obtained by using the Standard Industrial Classification (SIC) code, which is made available on the Internet through the Occupational Safety & Health Administration (OSHA) of the U.S. Department of Labor. In OSHA's website (osha.gov), searches can by conducted by keyword, producing a list of SIC codes, or by SIC code, producing descriptive information for a specified SIC. For example, entering the keyword “alcohol” produces a list of codes and short description. Nonalcoholic canned eggnog, for example, is a product associated with SIC code 2023 for Dry, Condensed and Evaporated Dairy Products, while alcoholic eggnog is associated with code 2085 for Distilled and Blended Liquors. The lines of business data retrieval means 26 includes means for retrieving such SIC information via Internet connection, which may or may not be the same network connection used for the financial data retrieval means 20, and it also includes non-computerized means, such as perusal of SIC standards or other manuals in print form, and telephone, facsimile, postal or other means initiated by a human operator to a company, for retrieving quantitative and qualitative information related to particular lines of business that prohibited, restricted or disapproved by Shariàh. The retrieval of lines of business data typically requires a large amount of manual, i.e. human operator, non-automated labor. Such manual retrieval is necessary because the automated retrieval of financial statements does not, in general, include a break down of financial data by lines of business.

On the other hand, the SIC codes for lines of business that correspond to a revenue percentage of greater than 5% are reported in the financial statements and are obtained as part of the retrieval of financial data 20. If SIC codes are reported and correspond to disapproved lines of business, then the company is rejected without further evaluation, because the fact that a particular disapproved SIC is reported means that the company derives disapproved income in excess of the allowable by the respective Shariàh-based rule for a 5% maximum. The screening for reported SIC codes is automated and may be included in the financial screen 24.

The subjective data retrieval means 30 may also include the same or duplicate of means already incorporated in the financial data retrieval means 20 or in the lines of business data retrieval means 26. For example, the same Internet connection may be shared by all the retrieval means 20, 26 and 30, or, alternatively, a network of computers operated by human personnel, each computer with individual access to the Internet, may be employed. Additionally, the subjective data retrieval means 30 may include perusal of various print media, site visitation, physical library search, reputation, etc, as well as information available online in the public domain or by subscription. In either case, subjective data retrieval requires labor-intensive, manual effort by a human operator.

Because the universe of publicly traded companies is large and expanding every day, the present invention, unlike the prior art, does not retrieve all types of data for each company 10 in an existing portfolio 12, a task that may involve manual, non-computerized retrieval for over 20,000 companies. Instead, the screening process is applied in a sequence that minimizes the manual labor required and, therefore, speeds up the screening process.

For a compliant portfolio, the filters include objective, qualitative and subjective, screening. Objective screening is based on a company's financial practices and in particular in the aspects involving interest paid or received. One of the clear tenets of Shariàh is against charging or receiving interest on loans. Modern corporations, however, regularly borrow funds for equipment, new hires, research and development, expansion into new branches and markets, and for other purposes. Contemporary interpretation of Islamic laws or Shariàh by Islamic scholars establishes one-third as the upper limit of such interest-based borrowing.

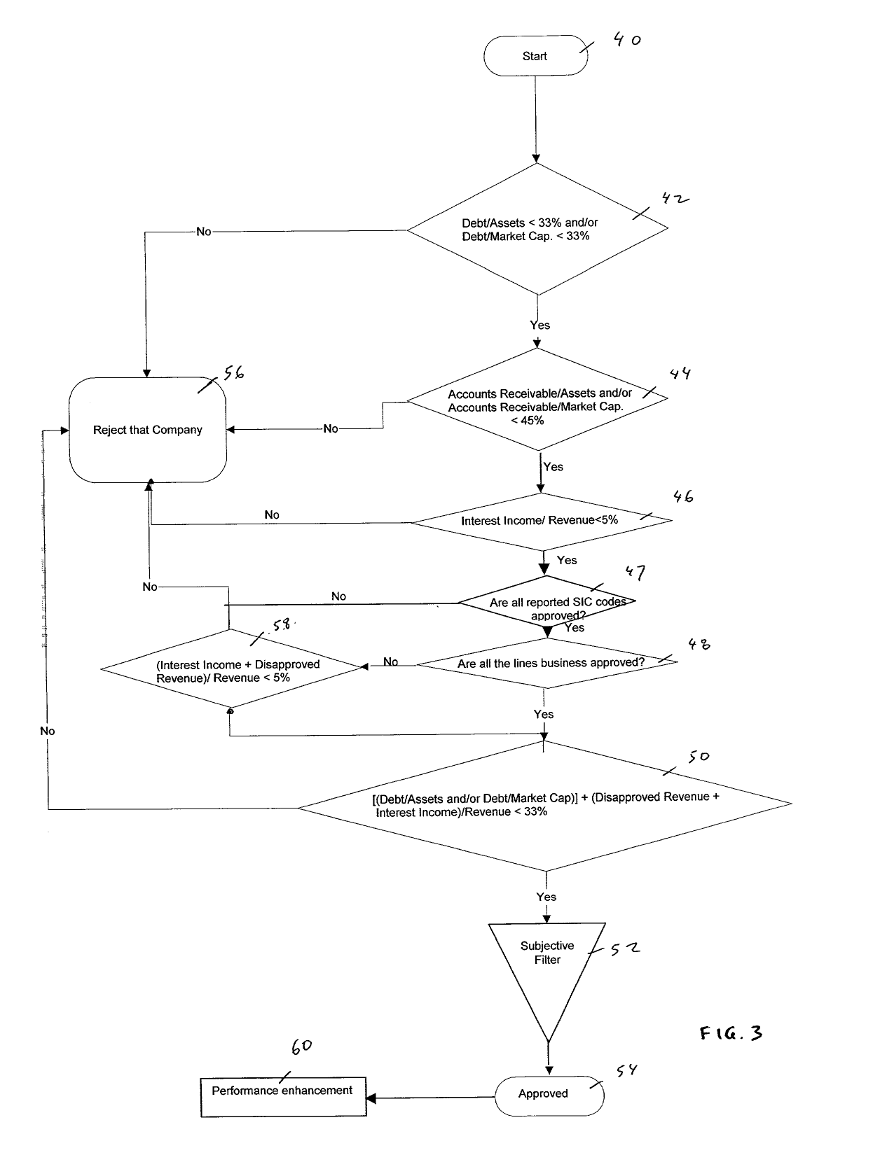

There is a split of Islamic (Shariàh ) authority on whether the proper ratio should be one-third of debt over assets, which is the book value of the borrowing ratio, or one third of debt over market capitalization, which reflects the market value of the borrowing ratio. To satisfy adherents of either interpretation, one embodiment of the invention imposes both ratios as requirements, as shown in FIG. 3, in which the book and market value of a company's borrowing is connected by the logical “and” in step 42. This means that the largest ratio is critical for compliance. It will be appreciated by the person of ordinary skill in the art that a logical “or”, instead of “and” connection may be used instead, if it is desirable to obtain custom-tailored answers for groups investors adhering to diverging interpretations of this Shariàh-based rule. Accordingly, step 42 shows both the logical “and” and the logical “or” choice. Another financial rule concerns the ratio of accounts receivable over assets and/or over market capitalization, which is required to stay below 45%. Choosing the logical “and” generally results in compliance to a stricter standard. Choosing the logical “or” provides for flexibility for compliance. A third financial rule requires that the ratio of interest income over revenue remain below 5%. It will be appreciated that new Shariàh scholarship may change or redefine these financial rules without affecting the scope of the invention.

The data for screening companies with the financial screen 24 includes, for example, information about debt, assets, accounts receivable, interest income, etc., and may be obtained for each existing portfolio company or a candidate company from commercially available databases, such as the databases available from Primark Corporation. The financial screen 24 filters each company for objective compliance with established permitted ratios, including reported SIC codes, such as described above. By placing this financial screen at the top of the system as the first screen that performs all the permitted ratio comparisons, such as steps 42, 44, 46 and 47 in the flowchart of FIG. 3, the present invention drastically departs from the prior art and achieves extraordinary time and resources economies. For example, it has been determining by testing that the financial screen 24 reduced the number of companies from 23, 596 to 5,008, thus reducing by almost fivefold (4.7 ratio) the number of companies requiring further screening for time-consuming qualitative or combined criteria that require some form of manual, non-automated labor. The reduction ratio represents a dramatic improvement over the prior art in which companies are screened first by manual or semi-manual filters that perform qualitative screening, such as inquiring into the nature of the primary business in which a company engages.

Examples of lines of business, which are prohibited as primary businesses, and from which revenue is disapproved include:

a. Financial institutions based on interest, such as conventional interest-based banks, moneylenders and finance houses; insurers; investment companies; stock brokerage and futures and options firms; and other interest based companies;

b. Alcoholic beverages, including the marketing, packaging, bottling, production, selling and distribution of alcoholic beverages;

c. Entertainment, such as products or services that are involved in gambling, casinos, lottery and pornography or adult content;

d. Prohibited food products, which include the raising or selling, marketing, packaging, production and distribution of pork, pork-derived products or by-products, and other prohibited food products;

e. Tobacco and tobacco-related products;

f. Weapons and military related equipment; and

g. Other prohibited products and services which may be included periodically based on current Shariàh-based scholarship and interpretation.

It will be appreciated that this is not an exhaustive listing and that it may change in time as new products and services are introduced, old products and services are modified and new Shariàh-based interpretations are issued.

Accordingly, the list of lines business that may be disapproved is rather large and comprises a vast array of products. Because currently revenue information corresponding to each line of business that is not reported by SIC code in the financial statement (because it falls below the 5% o revenue cutoff, although the aggregate of such unreported lines of business may exceed the 5% revenue) is mostly obtained by labor-intensive, manual means, such as telephone calls to the respective companies, reducing the number of the companies through the application of the financial screen 24 at the start of the screening process is does not simply provide a cost-effective and efficient means, but it safeguards the integrity of the compliant portfolio, when a thorough combined screening, such as the lines of business screening as well as any subjective screening into particular practices of a company is desirable. Subjective screening is any type of screening in which subjective criteria are used for rejecting companies, such as, for example, the criteria used by socially responsible investment funds, e.g. the socially responsible fund administered by the CALVERT GROUP.

The screen for lines of business 28 may include a step 48 for determining whether all lines of business of a given company are approved and, if the answer is no, a step 58 for determining whether restricted income, which is defined here is the sum of interest income plus income from disapproved lines of business calculated as a percentage of total revenue, remains below the predetermined permitted ratio of currently 5%. It is in this step that only 5,008 companies, instead of the initial 23,596 public companies for which data were available at the time of the test from Primark Corporation, require some manual retrieval of information.

As part of the same lines of business screen 28, a screening of combined restricted and finance-related information may be performed. For example, as shown in step 50 of FIG. 3, the percentage of restricted revenue (interest income plus disapproved income over total revenue) added to either the largest or one of the ratios of debt over assets and debt over market capitalization, must not exceed a predetermined permitted ratio of 33%. All the information required for the combined step 50 has already been obtained by the previous screenings.

The final screen for any companies remaining in the portfolio after the previously described screens have been applied is an additional subjective screen 32 for which retrieval of subjective data 30 via manual means may be necessary. The subjective screen 32 is similar to the socially responsible filters of other investment funds, such as the CALVERT GROUP, and requires the collection of data delving into management behavior, community involvement, etc. of a company. Such data is not available in financial statements, but may be obtained from press releases or other media. It may also be available online, on electronic newspapers or chat rooms, bulletin boards etc. Even though the information itself may be in electronic form, the work required for retrieving it is not automated and requires retrieval, selection and evaluation by a human operator. Although the subjective screening step 52 is the most labor-intensive process of the entire screening, in the present invention the amount of manual labor required has been minimized by putting this step 52 at the very bottom before final approval 54. Only companies that have passed the strict financial, lines of business/combined screens remain for the subjective screen test and their number is by then greatly reduced.

FIG. 3 shows a flowchart for an embodiment of the invention. After start 40, three financial screenings 42, 44, 46 and 47, as previously described, are performed. These screens use financial statement information including reported SIC codes available in commercial databases, such as those of Primark Corporation. The information is retrieved by automated computerized means. A great number of companies fail these three financial tests and are rejected 56. It will be appreciated that additional or different financial screening tests may be applied without departing from the scope of the invention, which requires that all screening be sequenced in such way that it minimizes the amount of manual labor required for screening. Therefore, all automated, non-manual screenings should be performed at the top, after the start 40 of the process. Non-automated screenings follow, again in order of increasing manual labor requirements. Accordingly, the financial screenings are followed by the lines of business 48 screen for unreported SIC codes and the combined screens 58 and 50. The subjective screen 52 is placed at the end of the process leading to the final approved 54 step which produces the list of companies making up the compliant portfolio. It is also understood, as illustrated in FIG. 2, that information required for each screening step is retrieved only for the companies not already rejected by previous screens. In this way, the screening process involves stepwise fewer companies, as each screening becomes more manual-labor intensive, and the manual retrieval process is, therefore, minimized. After a compliant portfolio is produced, the portfolio may be subjected to a performance enhancement screening 60. As is known in the art, such screening filters out companies based on financial data and projections so that it improves the financial performance of the portfolio and reduces the investment risks.

It will be understood that although, in particular embodiments, the permitted financial, restricted or combined ratios, the disapproved lines of business and other subjective standards may be rigidly defined, the dynamic evolution of Shariàh interpretation in view of current realities is accommodated by the overall flexibility of the system and method, which allows not only for changing the predetermined permitted ratios or approved lists, but also for the production of different portfolios dependent on variant Shariàh-based interpretations. The interdigitation of the sequence of retrieval and screen means that leads to the minimization of manual labor does not depend on such doctrinally vital details.

Whereas particular embodiments of the invention have been described herein for the purpose of illustrating the invention and not for the purpose of limiting the same, it will be appreciated by those of ordinary skill in the art that numerous variations of the details, materials and arrangement of parts may be made within the principle and scope of the invention without departing from the invention as described in the appended claims.

What is claimed is:

1. A method of screening a company for compliance to Shariàh-based principles, the method comprising sequentially:
a. comparing a first financial ratio calculated for the company with a first permitted financial ratio;
b. rejecting the company, if the first calculated financial ratio is greater or equal than the first permitted financial ratio;
c. if the company is not rejected, comparing a calculated percentage of restricted revenue with a permitted percentage of restricted revenue;
d. rejecting the company, if the calculated percentage of restricted revenue is greater or equal than the permitted percentage of restricted revenue;
e. if the company is not rejected, comparing a calculated combined financial and restricted ratio with a permitted combined financial and restricted ratio; and
f. rejecting the company if the calculated combined ratio is greater or equal than the permitted combined ratio.

2. The method of claim 1, wherein the first financial ratio is the ratio of the company's debt over the company's assets.

3. The method of claim 1, wherein the first financial ratio is the ratio of the company's debt over the company's market capitalization.

4. The method of claim 1, wherein the first financial ratio is the largest of the ratio of the company's debt over its assets and the ratio of the company's debt over its market capitalization.

5. The method of claim 1, further comprising before step c:
if the company is not rejected, rejecting the company if a reported Standard Industrial Classification code corresponds to a disapproved line of business.

6. The method of claim 1, further comprising before step c:
if the company is not rejected, comparing a second financial ratio calculated for the company with a second permitted financial ratio; and
rejecting the company, if the second calculated financial ratio is greater or equal than the second permitted financial ratio.

7. The method of claim 6, wherein the second financial ratio is the ratio of the company's accounts receivable over the company's market capitalization.

8. The method of claim 6, wherein the second financial ratio is the ratio of the company's accounts receivable over the company's assets.

9. The method of claim 6, wherein the first financial ratio is the ratio of the company s debt over the company's assets.

10. The method of claim 6, wherein the first financial ratio is the ratio of the company's debt over the company's market capitalization.

11. The method of claim 6, wherein the first financial ratio is the largest of the ratio of the company's debt over its assets and the ratio of the company's debt over its market capitalization.

12. The method of claim 6, wherein the second financial ratio is the largest of the ratio of the company's accounts receivable over its assets and the ratio of the company's accounts receivable over it s market capitalization.

13. The method of claim 1, further comprising before step c:
if the company is not rejected, comparing a interest income percentage calculated for the company with a permitted interest income percentage; and
rejecting the company, if the calculated interest income percentage is greater or equal than the permitted interest income percentage.

14. The method of claim 1, wherein the restricted revenue includes interest income and income from lines of business disapproved by Shariàh.

15. The method of claim 14, wherein the disapproved lines of business are determined by their Standard Industrial Classification codes.

15. The method of claim 1, wherein the combined financial and restricted ratio is the sum of the ratio of debt over assets and the percentage of interest and disapproved lines of business income.

16. The method of claim 1, wherein the combined financial and restricted ratio is the sum of the percentage of interest and disapproved lines of business income and the largest of the ratios of debt over assets and debt over market capitalization.

17. The method of claim 1, wherein the combined financial and restricted ratio is the sum of the percentage of interest and disapproved lines of business income and the ratio of debt over assets.

18. The method of claim 1, wherein the combined financial and restricted ratio is the sum of the percentage of interest and disapproved lines of business income and the ratio of debt over market capitalization.

19. The method of claim 1, further comprising after step f:
screening the company through a subjective filter, if the company is not already rejected.

20. A method of screening a company for compliance to Shariàh-based principles, the method comprising:
screening the company for compliance to a permitted ratio for debt over assets and debt over market capitalization;
screening the company for compliance to a permitted ratio for accounts receivable over assets and accounts receivable over market capitalization;
screening the company for compliance to a permitted ratio for interest income over revenue;
screening the company for compliance to approved Standard Industrial Classification codes;
subsequently screening the company for compliance to a permitted ratio for the sum of interest income over revenue and disapproved revenue percentage;
subsequently screening the company for compliance to a permitted ratio for the sum of the percentage of interest income and disapproved lines of business income and the largest of the ratios of debt over assets and debt over market capitalization; and
subsequently screening the company through a subjective filter, wherein a subsequent screening of the company stops if the company is rejected by the previous screening.

21. A method of screening a company for compliance to Shariàh-based principles, the method comprising:
screening the company for compliance to a permitted ratio for debt over assets or debt over market capitalization;
screening the company for compliance to a permitted ratio for accounts receivable over assets or accounts receivable over market capitalization;
screening the company for compliance to a permitted ratio for interest income over revenue;
screening the company for compliance to approved Standard Industrial Classification codes;
subsequently screening the company for compliance to a permitted ratio for the sum of interest income over revenue and disapproved revenue percentage;
subsequently screening the company for compliance to a permitted ratio for the sum of the percentage of interest income and disapproved lines of business income and the ratio of debt over assets or debt over market capitalization; and
subsequently screening the company through a subjective filter, wherein a subsequent screening of the company stops if the company is rejected by the previous screening.

22. A method of managing, according to Shariàh-based principles, an investment portfolio associated with a plurality of companies, the method comprising:
retrieving financial data about each company;
screening each company for compliance to permitted financial ratios and Standard Industrial Classification codes;
retrieving lines of business data about each company;
screening each company for compliance to permitted restricted ratios;
screening each company for compliance to a permitted combined financial and restricted ratio;
retrieving subjective data about each company; and
screening each company for compliance to subjective criteria, wherein there is no subsequent screening if the company is rejected by the previous screening and wherein the retrieving steps are sequenced so that manual retrieval is minimized.

23. The method of claim 22, further comprising screening all compliant companies for performance enhancement.

24. A method of managing according to Shariàh-based principles an investment portfolio associated with a plurality of companies, the method comprising:
retrieving automated computer retrievable data for each company and applying for each company an Shariàh-based filter that uses the computer retrievable data;
retrieving manually retrievable data for the companies that have not been rejected by the previous application of the Shariàh-based filter and re-applying the Shariàh-based filter using the manually retrievable data.

25. A system for managing, according to Shariàh-based principles, an investment portfolio associated with a plurality of companies, the system comprising:
means for retrieving and storing financial data obtained for each company;
means for screening each company using the financial data of the company and permitted financial ratios and Standard Industrial Classification codes;
means for retrieving and storing lines of business data for each company;
means for screening each company using the lines of business data of the company and permitted ratios including revenue from disapproved lines of business;
means of retrieving and storing subjective data about each company; and
means for screening each company using subjective data about the company and predetermined subjective criteria, wherein there is no subsequent screening if the company is rejected by the previous screening and wherein the means of retrieving data are sequenced so that the manual retrieval of data is minimized.
